(19) United States
(12) Patent Application Publication
(10) Pub. No.: US 2014/0289626 A1
(43) Pub. Date: Sep. 25, 2014

(54) CLOUD BASED AUDIO RECORDING SYSTEM

(71) Applicant: Cloudeck Inc., North York (CA)

(72) Inventors: Kenneth W. K. Wu, North York (CA); Luen Pan Chan, North York (CA)

(21) Appl. No.: 14/215,709

(22) Filed: Mar. 17, 2014

Related U.S. Application Data
(60) Provisional application No. 61/793,418, filed on Mar. 15, 2013.

(51) Int. Cl. G06F 17/30; G06F 3/0484; G06F 21/62

(52) U.S. Cl. CPC G06F 17/3074; G06F 21/6218; G06F 3/0484
USPC 715/716; 707/736

(57) ABSTRACT

The present disclosure relates to a cloud based system for compiling a series of brief recordings made by a plurality of different users sequentially to form an aggregated audio presentation. The system stores a plurality of user audio files which corresponding to a single audio presentation such as a song, conversation or presentation. Each brief recording is assigned a unique identifier indicating the corresponding presentation and the user that recorded the brief recording before the brief recording is uploaded to a server for storage. The plurality of brief recordings can be aggregated at the server into a single audio presentation that can be streamed back to users. Alternatively, the plurality of brief recordings can remain separate, wherein the plurality of brief recordings can be transmitted piecemeal to users in the order indicated by the unique identifiers to simulate an aggregated audio presentation.

### RELATED APPLICATION

The present application claims the benefit of U.S. Provisional Application No. 61/793,418 filed Mar. 15, 2013, which is incorporated herein in its entirety by reference.

### FIELD OF THE INVENTION

The present invention is generally directed to a system for allowing a plurality of individuals to remotely contribute to a single audio presentation. Specifically, the present invention is generally directed to a system for aggregating brief recordings made by users on client-enabled mobile devices into a single audio presentation.

### BACKGROUND OF THE INVENTION

In recent years, social media has advanced well beyond simply sharing images and messages with friends and family over the internet. More specifically, social media has advanced to include communication tools allowing social media users to communicate or collaborate via the internet in ways ordinarily prohibited by distance or business. Social networking sites, such as TWITTER, allow users to post and receive brief messages from their social media contacts. The short messages allow users to quickly and efficiently communicate information to individuals or large groups. Similarly, smart phone and computer applications, such as APPLE FACETIME or SKYPE, allow users to video conference with their social network contacts. The video and audio communication provides a more personal form of communication with a social media aspect.

However, even with the plethora of social networking communication available, there still remains a need for users to communicate brief audio messages to their social networking contacts. Moreover, unlike TWITTER where users can easily review the previous “tweets” to ascertain the context of each individual message, a plurality of unsorted audio recordings can create confusion and ultimately hinder the information to be communicated. Accordingly, there is a need for a system that not only allows users to share brief audio recordings with each other, but also organizes the audio recordings to provide context for the recordings.

### SUMMARY OF THE INVENTION

The present invention is generally directed to information systems and associated technologies, and more particular to systems and methods using computer systems for compiling a series of brief recordings made by a plurality of different users sequentially to form an aggregated audio presentation. Specifically, the present invention is directed to a system for aggregating a plurality of remotely-made brief recordings at a server into a single audio recording or presenting the audio recordings to simulate a single audio recording. The present invention is specifically directed to brief recordings, such as recordings of less than about 20 seconds, rather than longer recordings as the brief recordings more closely resemble ordinary conversation between multiple parties or group “karaoke-type” group singing. This approach allows multiple users that are remote from each other and working, in embodiments, at different times, to collaborate on a single audio presentation while giving the impression that the single audio presentation was jointly recorded at the same location. Following recording, each brief recording is assigned a unique identifier indicating the corresponding audio presentation and the user that recorded the brief recording before the brief recording is uploaded to a server for sorting and storage. In certain aspects, the plurality of brief recordings can be aggregated at the server into a single audio presentation that can be streamed back to users. In other aspects, the plurality of brief recordings can remain separate, wherein the plurality of brief recordings can be transmitted piecemeal to users in the order indicated by the unique identifiers to simulate an audio presentation.

In certain embodiments, the present invention is directed to a system in which a first user records a base audio file on an initiating client provided on a first mobile device, wherein a mobile device is a type of computer system. The base audio file is uploaded to a server that assigns a primary identifier to the base audio file including information such as the first user and the audio presentation for which the base audio file is recorded. A second user can then search for the base audio file on the server and record at least one stem audio file corresponding to the base audio file via a secondary client provided on a second mobile device. As with the base audio file, a subset identifier is assigned to the stem audio file prior to upload to the server, the subset identifier including information such as the second user and the corresponding base audio file. When multiple stem files are recorded, the subset identifier can also indicate the relative order of the particular stem audio file relative to the other stem files. Users can then stream the base audio file and stem recordings from the server either as an assembled single audio presentation or a piecewise group of audio files, wherein the primary identifier and subset identifier identifies the correct order for the base audio file and stem audio files.

In certain embodiments, the primary identifier can also include user-defined permissions limiting access to the base audio file on the server. In embodiments, user-defined permissions additionally include modification rights to add stem audio files to the base audio files or to modify other aspects of the audio presentation such as an order of the stem audio files. In certain aspects, the system can be linked to social networking databases such that a “friend's list” for the initiating user can be downloaded to the system, wherein the user can then identify whether the base audio file can be shared globally, limited to his or her friends or a subset thereof. In certain aspects, the server can further comprise a list of system users, wherein the initiating user selects which system users have access and modification rights to the base audio file or the audio presentation as a whole. For example, in embodiments, the initiating user can publish or otherwise make available the base audio file or the audio presentation as a whole. In embodiments, a secondary user, such as one of the “friends” of the initiating user or a subset of the “friends” of the initiating user, according to the permissions granted by the initiating user, can publish or otherwise make available the base audio file or the audio presentation as a whole. In embodiments, the server can by default limit or restrict which “friends” of the initiating user or subset of the “friends” of the initiating user can add stem audio files.

This access and modification rights permission setting is readily understood to be transferrable to the trees or circles of hierarchies of “friends.” For example, according to permissions stipulated by the initiating user, only second generation contacts (friends of friends) can download the base audio file or the audio presentation as a whole. In an embodiment, only second generation contacts can add stem audio files. In another embodiment, only first generation contacts (friends) can download the base audio file or the audio presentation as a whole. In an embodiment, only first generation contacts can add stem audio files. In an embodiment, the initiating user selects which system users have read access to the base audio file, the one or more stem audio files, or the audio presentation as a whole. In embodiments, the initiating user selects which system users have write or modify access to the base audio file, the one or more stem audio files, or the audio presentation as a whole. Accordingly, in embodiments, the selected read/write access can be applied by group or relation to the initiating user or other user according to, for example, social networking database data or social networking database data hierarchies.

In certain embodiments, the primary identifier can also include user-defined permissions allowing the initiating user to pass or hand off permission control for the base audio file, the one or more stem audio files, or the audio presentation as a whole. For example, an initiating user can pass off, to a secondary user, the controls that define access and modification rights. In embodiments, both the initiating user and the secondary user retain permission control rights to define access and modification rights for other users, such that there are at least two “master” users. In certain embodiments, control permission can be delegated to the secondary user or group of users instead of being retained by the initiating user. In certain embodiments, the initiating user can reclaim permission control rights from the secondary user or second master user, such that the second master user reverts to a non-master user.

In embodiments wherein two or more master users retain permission control rights, a semaphore or access control mechanism such as a mutex can be utilized in order to safely adjust permissions. Moreover, semaphores or access control can be utilized for safely maintaining control over the base audio file, the one or more stem audio files, or the audio presentation as a whole.

A system for creating an audio presentation by sequentially adding stem audio files to a base audio file, according to an embodiment of the present invention, can comprise an initiating client, at least one secondary client and a server. The initiating client is provided on a first mobile device and can comprise a user interface, a recording module and an audio file processing module. Similarly, the secondary client is provided on a second mobile device and can similarly comprise a user interface, a recording module and an audio file processing module. For the purposes of this disclosure, a computer system or mobile device can comprise a mobile phone, a tablet computer, a laptop with recording capabilities, a television with recording capabilities, wrist watches with recording capabilities and other mobile devices having a visual display, recording capabilities and networking capabilities for linking the mobile device to a wireless network or the internet. The server can further comprise a database and a binary large object (BLOB) storage module.

In operation, a first user operates the recording module of the initiating client through the user interface to record a base audio file. The recording module limits the length of the base audio file to a first predetermined time period, wherein the user interface provides a visual indicator of the length of time remaining in the first predetermined time period. The visual indicator can comprise a size changing shape, a visual timer, a clock face or other conventional means of indicating a shortening time period. In certain aspects, the initiating client can further comprise a player module for playback of the record base audio file, wherein the user can delete or re-record the base audio file if unsatisfactory. Upon approval by the user, the file processing module can tag the base audio file with at least one primary indicator. In certain aspects, the first user can set permissions that are included in the primary indicator as to which system user can have access to and add stem audio files to the base audio files. The base audio file is uploaded to the server where the base audio file is stored in the BLOB storage module and the server creates a database entry in the database corresponding to the identifying indicator assigned to the base audio file.

A second user can then operate the user interface of the secondary client to browse the database and locate the base audio file from the database entry if the second user meets the permission criteria set by the first user. In certain aspects, the secondary client can retrieve the base audio file from the BLOB storage module to play the base audio file. Alternatively, the secondary client can dynamically stream the base audio file from the BLOB storage module. The second user can then operate the recording module of the secondary client through the user interface to record a stem audio file. The recording module limits the length of the stem audio file to a second predetermined time period, wherein the user interface provides a visual indicator of the length of time remaining in the second predetermined time period. In certain aspects, the second predetermined time period can be same or shorter than the first predetermined time period. Upon approval by the second user, the file processing module can tag the second audio file with an identifying indicator corresponding to the identifying indicator of the base audio file. The stem audio file can then be uploaded to the server and stored with the BLOB storage module. Accordingly, in embodiments, the server creates a second database entry in the database.

A method of creating an audio presentation by sequentially adding stem audio files to a base audio file, according to an embodiment of the present invention, comprises providing an initiating client on a first mobile device and comprising a user interface, a recording module and an audio file processing module. The method can further comprise operating the recording module of the initiating client via the user interface to record a base audio file. The method can further comprise assigning a primary indicator to the base audio file. The method can further comprise uploading the base audio file to a server.

The method can also comprise providing a secondary client on a second mobile device and comprising a user interface, a recording module and an audio file processing module. The method can also comprise searching the server and locating the base audio file. The method can further comprise operating the recording module of the second client via the user interface to record a stem audio file. The method can further comprise assigning a secondary indicator to the stem audio file, wherein the secondary indicator indicates the relationship of the stem audio file to the base audio file. The method can also comprise uploading the stem audio file to a server. Finally, the method can also comprise grouping the stem audio file with the base audio file based on the information in the primary and secondary indicators.

The above summary of the various representative embodiments of the invention is not intended to describe each illustrated embodiment or every implementation of the invention. Rather, the embodiments are chosen and described so that others skilled in the art can appreciate and understand the principles and practices of the invention. The figures in the detailed description that follow more particularly exemplify these embodiments.

### BRIEF DESCRIPTION OF THE DRAWINGS

The invention can be completely understood in consideration of the following detailed description of various embodiments of the invention in connection with the accompanying drawings, in which:

FIG. 1 is a schematic diagram of a system for assembling and organizing a plurality of brief recordings according to an embodiment of the present invention.

FIG. 2 is a schematic diagram of a system for assembling and organizing a plurality of brief recordings according to an embodiment of the present invention.

FIG. 3 is a schematic diagram of a system for assembling and organizing a plurality of brief recordings operably coupled to a social networking database, according to an embodiment of the present invention.

FIG. 4 is a flowchart of a method for assembling and organizing a plurality of brief recordings according to an embodiment of the present invention.

FIG. 5 is a block diagram of a base audio file having overlaid stem audio files according to an embodiment of the present invention.

FIG. 6A is a flowchart of a method for an initiating user accessing a contact database for assembling and organizing a plurality of brief recordings according to an embodiment of the present invention.

FIG. 6B is a flowchart of a method for a secondary user contributing to assembling and organizing a plurality of brief recordings according to an embodiment of the present invention.

FIG. 7 is a representative perspective view of the operation of a system for assembling and organizing a plurality of brief recordings on a smart phone according to an embodiment of the present invention.

FIG. 8 is a representative perspective view of the operation of a system for assembling and organizing a plurality of brief recordings on a tablet computer according to an embodiment of the present invention.

FIG. 9 is a representative perspective view of the operation of a system for assembling and organizing a plurality of brief recordings on a television according to an embodiment of the present invention.

FIG. 10 is a representative perspective view of the operation of a system for assembling and organizing a plurality of brief recordings on a wrist worn mobile device to an embodiment of the present invention.

FIG. 11 is a schematic diagram of a computer system for use with a system for assembling and organizing a plurality of brief recordings according to an embodiment of the present invention.

FIG. 12 is a representative view of a user interface for the operation of a system according to an embodiment of the present invention.

FIG. 13 is a representative view of a user interface for the operation of a system according to an embodiment of the present invention.

FIG. 14 is a representative view of a user interface for the operation of a system according to an embodiment of the present invention.

FIG. 15 is a representative view of a user interface for the operation of a system according to an embodiment of the present invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION

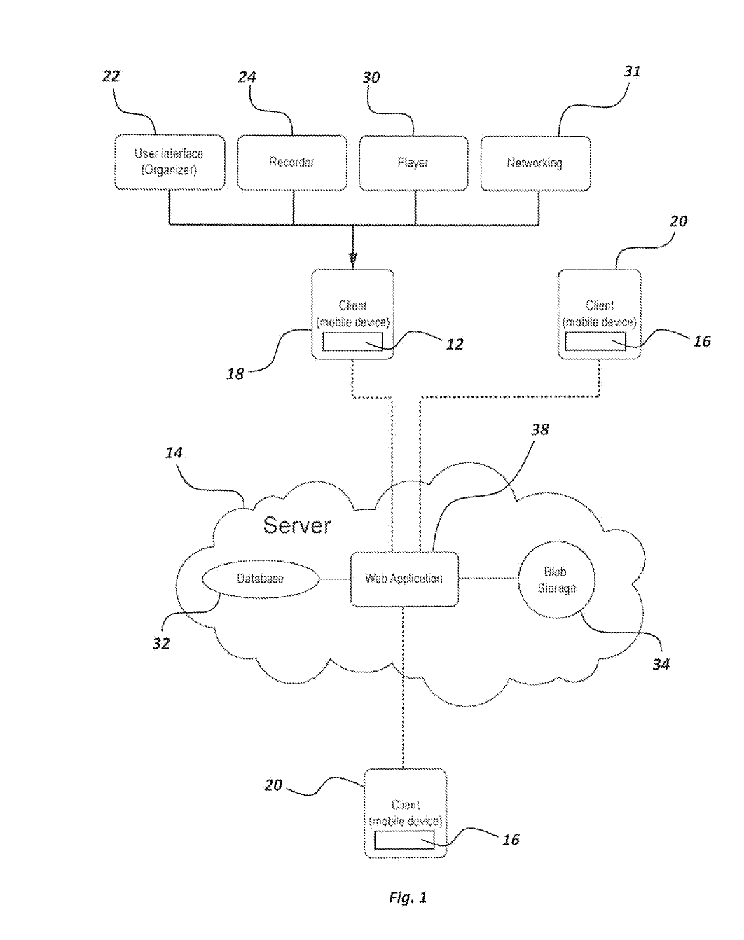

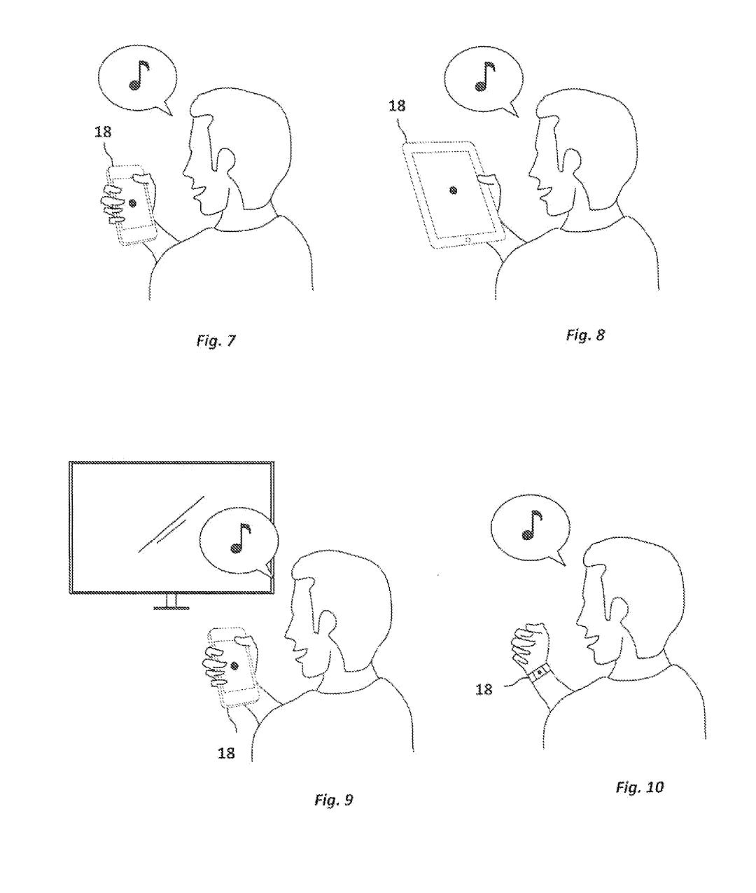

As depicted generally in FIGS. 1-4, a system 10 for combining a plurality of brief recordings into a single audio presentation or arranging the brief recordings to simulate a single audio recording, according to an embodiment of the present invention, generally comprises an initiating client 12, a server 14 and at least one secondary client 16. The initiating client 12 is provided on a computer system such a first mobile device 18, while the secondary client 16 is provided on a second mobile device 20. For the purposes of this disclosure, a computer system or mobile device 18, 20 can comprise a mobile phone, a tablet computer, a laptop with recording capabilities, a television with recording capabilities, wrist watches with recording capabilities and other mobile devices having a visual display, recording capabilities and networking capabilities for linking the mobile device to a wireless network or the internet as depicted in FIGS. 7-10.

The initiating client 12 further comprises a user interface 22, a recording module 24 and an audio file processing module 26. In operation, a first user or organizer operates the recording module 24 of the initiating client 12 with the user interface 22 to record a base audio file to the first mobile device 18. In certain embodiments, the initiating client 12 can further comprise a timing module 28 that limits the length of the base audio file to a predetermined time period. In certain aspects, the predetermined time period can comprise less than about 30 seconds. In other aspects, the predetermined time period can comprise less than about 20 seconds. In yet other aspects, the predetermined time period can comprise less than about 10 seconds. In certain embodiments, the initiating client 12 can also comprise a player module 30 allowing the first user to replay the recorded base audio file and amend or re-record the base audio file. The audio file processing module 26 is then operated to assign a primary indicator to the base audio file. In certain aspects, the primary indicator can comprise information including, but not limited to the identification of the first user and information on the overarching audio recording to which the base audio file is intended to belong to.

With regards to reference to the recording module 24, the audio file processing module 26, the timing module 28 and the player module 30, the term module as used above and throughout the present disclosure means a real-world device, component, or arrangement of components implemented using hardware, such as by an application specific integrated circuit (ASIC) or field-programmable gate array (FPGA), for example, or as a combination of hardware and software, such as by a microprocessor system and a set of instructions to implement the module's functionality, which (while being executed) transform the microprocessor system into a special-purpose device. A module can also be implemented as a combination of the two, with certain functions facilitated by hardware alone, and other functions facilitated by a combination of hardware and software. In certain implementations, at least a portion, and in some cases, all, of a module can be executed on the processor core(s) of the mobile device 18, 20. Accordingly, each module can be realized in a variety of suitable configurations, and should not be limited to any particular implementation exemplified herein.

In certain aspects, the initiating client 12 can be linked to a social networking site for downloading client information relating to the first user's contacts. In this configuration, the primary indicator can include permission information limiting access to the base audio file to, for example, the user's social networking contacts or a subset thereof. Alternatively, the system 10 can comprise its own list of users from which the initiating client 12 can designate users that have permission to access the base audio file and add stem audio file to base audio file.

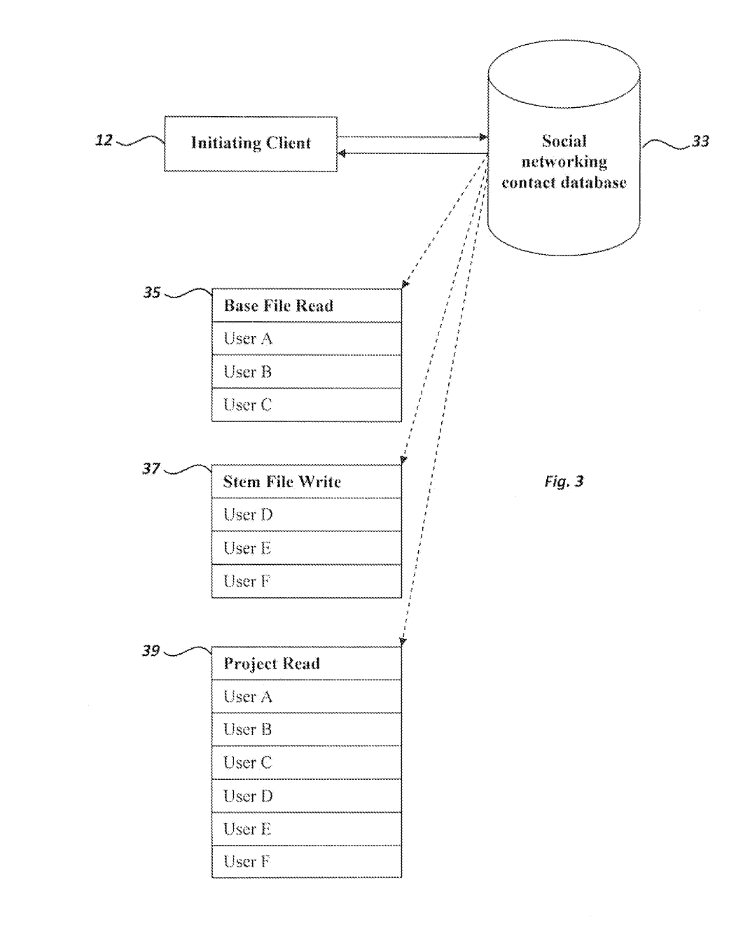

For example, referring to FIG. 3, the initiating client 12 can be operably coupled to a social networking site or social networking contact database 33, as illustrated. In embodiments, contact database can comprise data storage from FACEBOOK, TWITTER, LINKEDIN, INSTAGRAM, or any other suitable contact database. The initiating client 12 can interface or communicate with social networking contact database 33 such that a “friend's list” or other relational data for the initiating user can be downloaded to the system 10. In embodiments, a “friend's list” or other relational data can be downloaded to initiating client 12 and subsequently relayed to server 14. According to embodiments, the initiating client 12 is further configured to identify whether a base audio file can be shared globally, limited to his or her friends, or a subset thereof. In other embodiments, the server 14 can receive data directly from the contact database 33. In embodiments, data received by the server 14 can comprise a list of system users, wherein the initiating user can select which system users have access and modification rights to at least one of the base audio file, stem audio files, or the audio presentation as a whole.

As shown in FIG. 3, a friend list 35 can be queried or otherwise downloaded by system 10 from contact database 33. As illustrated, friend list 35 comprises a list of users granted permission to read the base file. In an embodiment, the friend list 35 comprises User A, User B, and User C. Granting read permissions to the users of the friend list 35 can be utilized as a sort of “sneak preview” of the base file for the to-be-completed audio project. For example, the “friends-of-friends” of the initiating client 12 that comprises the group of User A, User B, and User C can be granted the aforementioned read permissions.

A friend list 37 can likewise be queried or otherwise downloaded by system 10 from contact database 33. The friend list 37 can comprise a different or secondary group of users. As illustrated, friend list 37 comprises a list of users granted permission to write or edit a stem file to the audio presentation. In an embodiment, the friend list 37 comprises User D, User E, and User F. For example, the “friends” of the initiating client 12 that comprises the group of User D, User E, and User F can be granted the aforementioned write/edit permissions. In such an embodiment, the audio project can be a collaboration between the initiating client 12 and his “friends,” according to data derived from contact database 33. In embodiments, the list of users granted permission to write or edit a stem file to the audio presentation can overlap with the list of users granted permission to read the base file. In typical projects, the users granted stem file write permission will also have base file read permissions in order to hear the base file for which stem file users are adding or editing stem files.

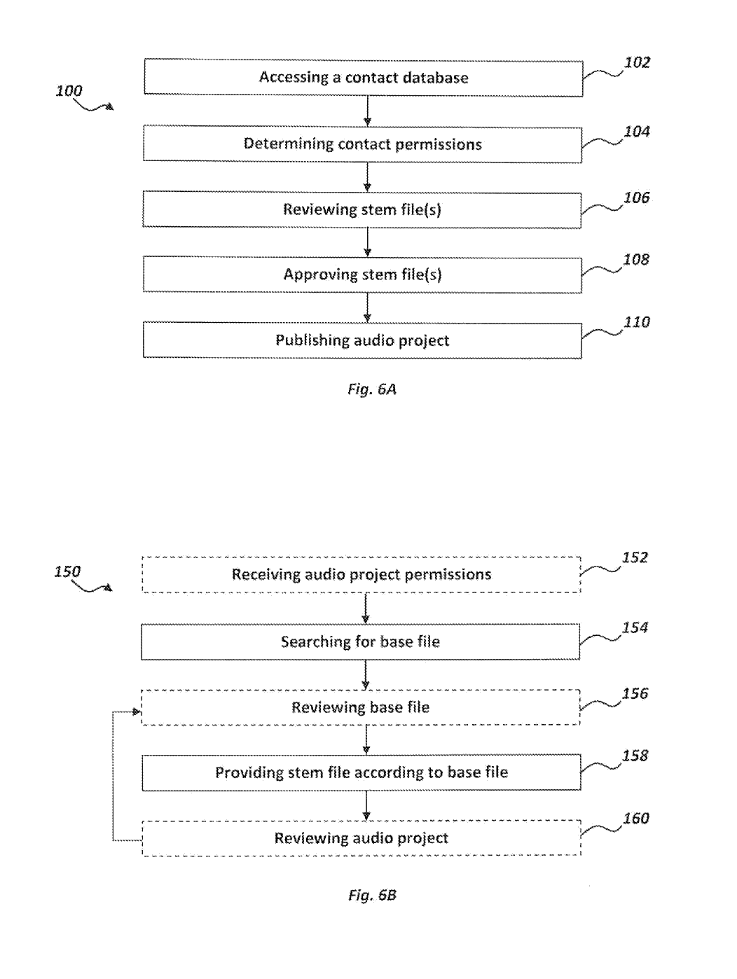

Once completed, the audio project can be published or otherwise provided access to by initiating client 12. A friend list 39 can be queried or otherwise downloaded by system 10 from contact database 33. The friend list 39 can comprise an aggregated list of the initiating client's “friends,” Users D, E, and F, as well as the initiating client's “friends-of-friends,” Users A, B, and C. In such an embodiment, the collaborative audio project between the initiating client 12 and his “friends,” is published to those users provided a chance to work on the project, such as friend list 37, as well as those who may be interested in the project by nature of the respective relational relationships to initiating client 12, such as friend list 35. In embodiments, the relational data queried from contact database 33 can comprise any unique set or overlapping set of data, according to the various users or applications, and are not limited to the examples provided above. Various methods and workflows will be further described below with respect to FIGS. 6A and 6B.

Referring again to FIG. 1, the server 14 further comprises a database 32 and a BLOB storage module 34. In operation, the base audio file is uploaded to the server 14, wherein the base audio file is stored on the BLOB storage module 30. In certain aspects, the initiating client 12 can further comprise a networking module 31 for facilitating the upload of the base audio file to the database 32. Similarly, an entry is entered into the database 32 based on the primary indicator assigned to the base audio file. In certain aspects, the server 14 can further comprise a search function 36 allowing users to access the database 32 via the initiating client 12 or the secondary client 16 such that users can browse and search the database 32 for entries corresponding to base audio file. Similarly, the server 14 can further comprise a web application 38 allowing users to access the database 32 via the internet.

The secondary client 16 further comprises a user interface 40, a recording module 42 and an audio file processing module 44. In operation, a second user can operate the recording module 40 of the secondary client 16 with the user interface 40 to record a stem audio file to the second mobile device 20. In certain embodiments, the secondary client 16 can further comprise a timing module 46 limiting the length of the base audio file to a predetermined time period. In certain aspects, the predetermined time period can comprise less than 30 second. In other aspects, the predetermined time period can comprise less than 20 seconds. In yet other aspects, the predetermined time period can comprise less than 10 seconds. In certain embodiments, the secondary client 16 can also comprise a player module 48 allowing the second user to replay the recorded base audio file and amend or re-record the stem base file. The audio file processing module 44 is then operated to assign a secondary indicator to the stem audio file. In certain aspects, the secondary indicator can comprise information including, but not limited to the identification of the second user, information on the audio recording to which the stem audio file corresponds and relative order of the stem file with other stem files created by the secondary client 16 operated by the second users or other secondary clients 16.

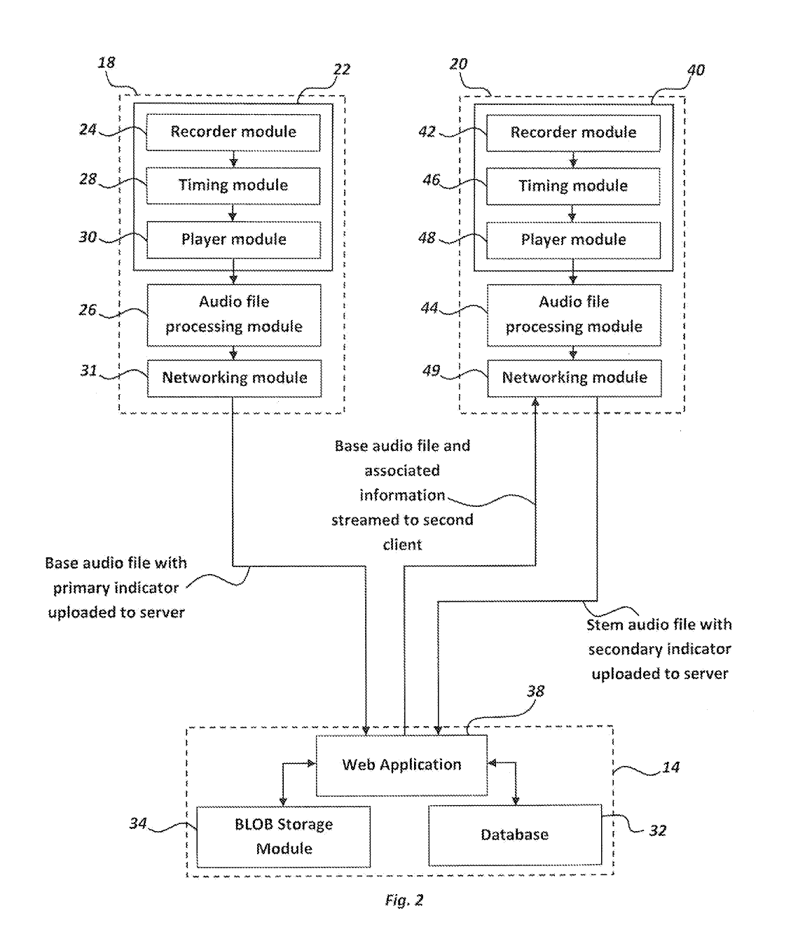

As depicted in FIG. 2, in operation, the stem audio file can be uploaded to the server 14, wherein the stem audio file is stored on the BLOB storage module 34. In certain aspects, the secondary client 16 can further comprise a networking module 49 for facilitating the upload of the stem audio file to the database 32. A new entry can be made in the database 32 corresponding to the stem audio file, wherein the new entry includes a reference to the entry for the base audio file. Alternatively, the entry in the database 32 corresponding to the base audio file can be modified to include information on the stem audio file.

In operation, the server 14 can stream the base audio file and the stem audio file to the mobile devices or via the internet. The server 14 reviews the primary and secondary indicators to stream the base audio file and stem audio files in the appropriate order. In certain aspects, the server 14 can combine the base audio file and stem audio files into a single audio presentation. Alternatively, the server 14 can provide the base audio file and the stem audio file in piecewise, sequential form so as to simulate an aggregated single audio presentation. In certain aspects, either the first user or the second user can edit the audio files uploaded by the specific users at the server. In other embodiments, the first user can define permission limitations that limit which users can add to, delete from, or alter the audio presentation.

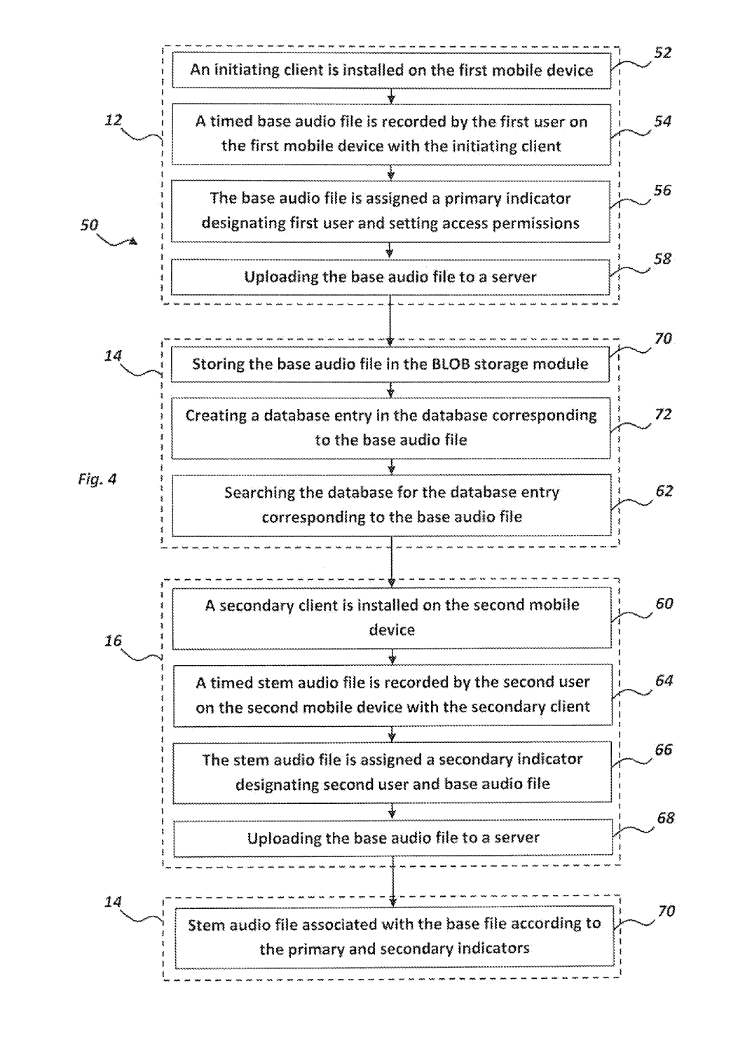

As depicted in FIG. 4, a method 50 of creating an audio presentation by sequentially adding stem audio files to a base audio file, according to an embodiment of the present invention, comprises an installation step 52 in which an initiating client 12 is provided on a first mobile device 18 and comprising a user interface 22, a recording module 24 and an audio file processing module 26. The method can further comprise an initial recording step 54 in which the first user operates the recording module 24 of the initiating client 12 via the user interface 22 to record a base audio file. In certain aspects, a timing module 28 of the initiating client 12 will disable the recording module 24 if the base audio file exceeds a predetermined length. The method can further comprise a first designation step 56 in which a primary indicator is assigned to the base audio file. The method can also further comprise a first upload step 58 in which the base audio file and corresponding primary indicator is uploaded to a server 14.

In certain aspects, the method can further comprise a storage step 70 in which the base audio file is stored on the BLOB storage module 34. In this configuration, the method can also further comprise recordation step 72 in which a database entry in made in the database 32 corresponding to the base audio file stored on the BLOB storage module 34 allowing users to search the database 32 for the base audio file.

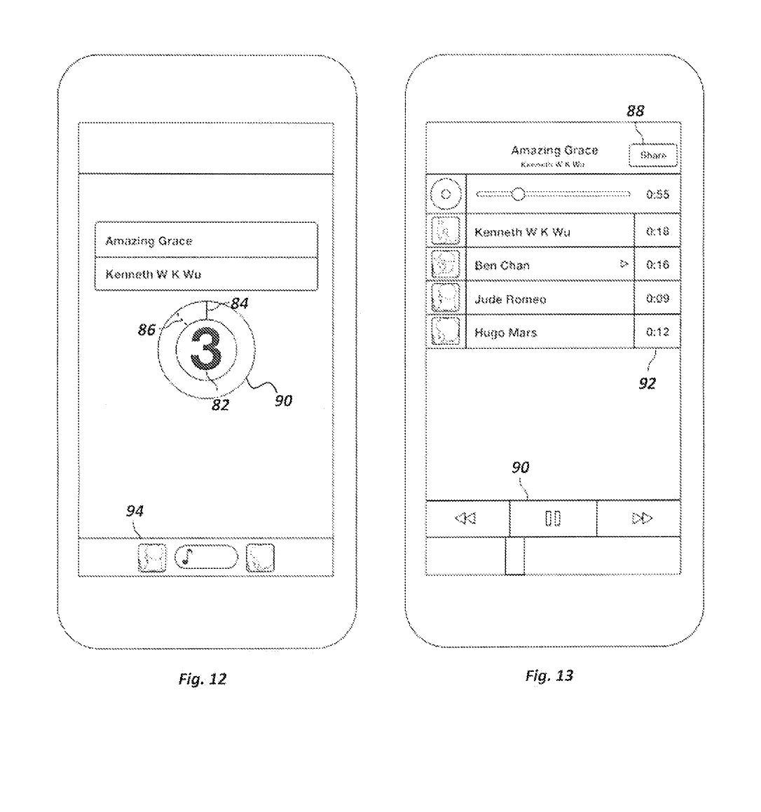

As depicted in FIGS. 12-15, in certain embodiments, the user interfaces 22, 40 of the initiating client 12 and the secondary client 16 respectively provide an interactive display for the first or second user. In certain aspects, the interactive display can include a visual timer indicator 80 for the timing module 28, 46. The timer indicator 80 can comprise a numerical countdown 82 and/or a visual countdown with a changing visual element that indicates the difference between the start point 84 and the completion point 86. In certain aspects, the user interfaces 22, 40 can further comprise command buttons such as an upload button 88 or player module 30, 48 control buttons 90 that can be pressed to operate the various features of system 10. In certain aspects, the user interfaces 22, 40 can further comprise a complete play list 92 listing each base audio file or stem audio file included in the presentation. Alternatively, or in addition to a shortened play list 94 that indicates the preceding and subsequent audio file for the audio file presently being recorded.

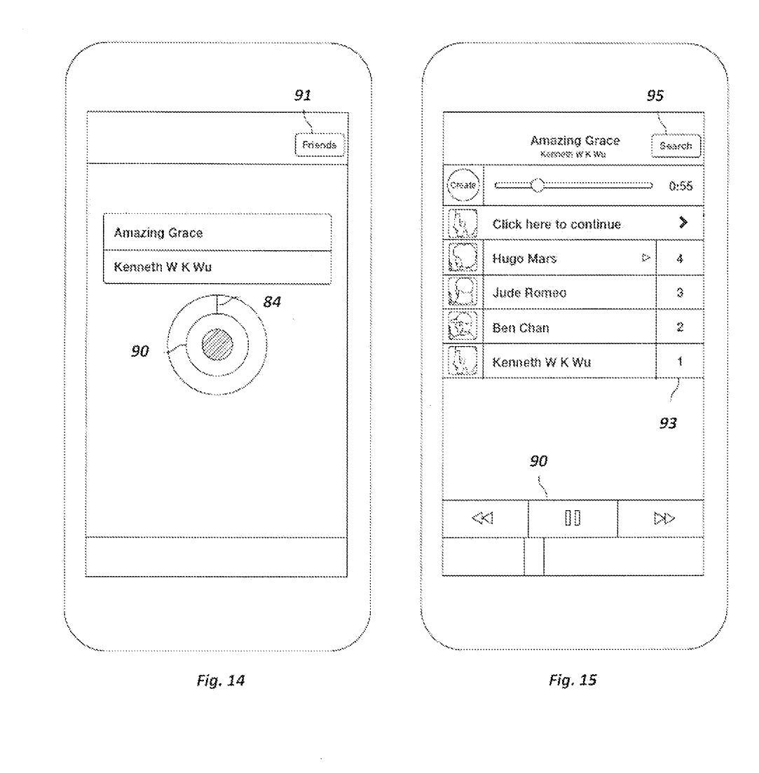

For example, in an embodiment, FIG. 12 illustrates a recording interface for a secondary (or other non-initiating user). In an embodiment, FIG. 13 illustrates a play list 92 listing each base audio file or stem audio file included in the presentation for a published audio project. Similarly, in an embodiment, FIG. 14 illustrates a recording interface for an initiating user. In certain embodiments, the user interfaces 22, 40 can further comprise a “Friends” button 91. “Friends” Button 91 comprises an interface to the social networking contacts the initiating user wishes to grant base file read access, stem file write access, or other appropriate access. In embodiments (not shown), user interfaces 22, 40 can comprise additional contact button interfaces in order for the initiating user (or delegated user, in embodiments) to grant access. FIG. 15 illustrates a play list 93 listing each of the unpublished stem audio files. In certain embodiments, the user interfaces 22, 40 can further comprise Search button 95. Search button 95 comprises, in an embodiment, an interface to allow the initiating user (or delegated user, in embodiments) to search for other users in order to grant additional access. In other embodiments, Search button 95 comprises an interface to allow the initiating user (or delegated user, in embodiments) to search for non-listed stem audio files for the particular audio project. In other embodiments, as secondary users add a respective stem audio file, the file is dynamically and automatically populated into the user interfaces 22, 40 for the initiating user. In other embodiments, the interfaces of FIGS. 14-15 can be utilized by a secondary or non-initiating user.

Referring again to FIG. 4, the method 50 can further comprise a second installation step 60 in which a secondary client 16 is provided on a second mobile device 20, the secondary client 16 comprising a user interface 40, a recording module 42 and an audio file processing module 44. The method can also comprise a searching step 62 in which the second user searches the server 14 via the second client 16 to locate the primary indicator. The method can further comprise a second recording step 64 in which the second user operates the recording module 42 of the second client 16 via the user interface 40 to record a stem audio file. The method can further comprise a second designation step 66 in which a secondary indicator is assigned to the stem audio file, wherein the secondary indicator indicates at least the relationship of the stem audio file to the base audio file. The method can also comprise a second uploading step 68 in which the stem audio file is uploaded to the server 14. Finally, the method can also comprise an aggregation step 70 in which the stem audio file is associated with the base audio file on the server 14 based on the information in the primary and secondary indicators.

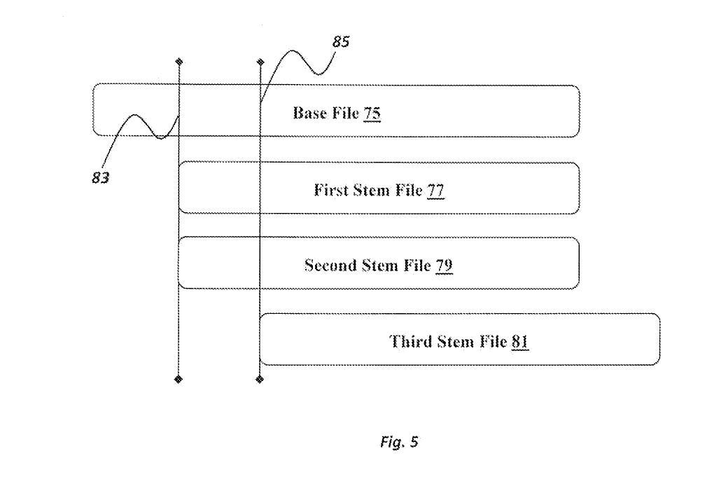

Referring to FIG. 5, a block diagram of a base audio file having overlaid stem audio files, according to an embodiment, is depicted. As depicted in FIG. 5, base file 75, first stem file 77, second stem file 79, and third stem file 81 reflect a recording duration along their respective lengths. Referring specifically to FIG. 5, base file 75 can comprise an output from method 50, and particularly recording step 54 in which the first user operates the recording module 24 of the initiating client 12 via the user interface 22 to record a base audio file 75. First stem file 77 can comprise an output from method 50, and particularly second recording step 64 in which the second user operates the recording module 42 of the second client 16 via the user interface 40 to record a stem audio file. As described above, an indicator 83 can be generated by the second designation step 66 in which a secondary indicator is assigned to a stem audio file, such as first stem file 77, wherein the secondary indicator indicates at least the relationship of the first stem file 77 to the base audio file 75.

Second stem file 79 can comprise an output from method 50 similar to recording step 64, but for a third user instead of the second user. Alternatively, in embodiments, second stem file 79 can be generated according to method 50 by initiating client 12 or the second user. In embodiments, indicator 83 can further comprise the relationship of the second stem file 79 to the base audio file 75. In embodiments (not shown), first stem file 77 and second stem file 79 can be overlaid at different points according to the relationship to the base file 75.

Third stem file 81 can comprise an output from method 50 similar to recording step 64, but for a fourth user instead of the third user or second user. Alternatively, in embodiments, third stem file 81 can be generated according to method 50 by initiating client 12, the second user, or the third user. An indicator 85 can be generated by a step similar to second designation step 66 in which indicator 85 is assigned to third stem file 81, wherein the indicator 85 indicates at least the relationship of the third stem file 81 to the base audio file 75. Alternatively, indicator 85 can be generated to be assigned to third stem file 81, wherein the indicator 85 indicates at least the relationship of the third stem file 81 to either the first stem file 77 or the second stem file 79.

In other embodiments (not shown), first stem file 77, second stem file 79, and/or third stem file 81 can be overlaid on base file 75 such that none of the files overlap. For example, first stem file 77 can be stitched to base file 75 to effectively be concatenated with base file 75. Second stem file 79 can be stitched to first stem file 77 to effectively be concatenated with first stem file 77. Third stem file 81 can be stitched to second stem file 79 to effectively be concatenated with second stem file 79. In such embodiments, the audio from the respective base file 75, first stem file 77, second stem file 79, and/or third stem file 81 do not overlap with each other, and the aggregated recordings are operably coupled to play sequentially.

As described above, the system 10 can be operably coupled to one or more social networking sites or social networking contact databases, such as contact database 33 depicted in FIG. 3. Referring to FIG. 6A, a flowchart of a method 100 for an initiating user 12 accessing a contact database for assembling and organizing a plurality of brief recordings is depicted, according to an embodiment. At 102, the initiating user 12 can access a contact database, such as contact database 33. In other embodiments, system 10 or components of system 10 as described above are configured to access contact database 33. In such embodiments, initiating user 12 accesses the relevant portion of system 10 where contact database 33 data is stored. At 104, contact permissions for the contact data retrieved or accessed from contact database 33 can be determined or assigned. As discussed with respect to FIG. 3, initiating user 12 can assign individual users or groups of users permissions related to the audio project, including read/write access to the base audio file, components of the audio presentation (future stem files) or the audio presentation as a whole. At 106, after one or more secondary users have provided one or more stem audio files, initiating user 12 can review the stem files. System 10 is therefore configured to provide initiating user 12 with the stem files for review. In embodiments, stem files can be reviewed individually, or in combination with the underlying base audio file. In embodiments, multiple stem files can be reviewed at one time. At 108, initiating user 12 can approve one or more stem files to be added to the audio project. Likewise, initiating user 12 can remove or “unapproved” one or more stem files for the audio project. At 110, once initiating user 12 is satisfied with the base file in combination with the one or more stem files, the audio project can be published or otherwise provided for access. In embodiments, publishing comprises granting read access to a user or group of users. In another embodiment, publishing comprises transmitting the audio project to a user or group of users.

Likewise, referring to FIG. 6B, a flowchart of a method 150 for a secondary user contributing to assembling and organizing a plurality of brief recordings is depicted, according to an embodiment. At 152, optionally, the secondary user can receive audio project permissions for one or more audio projects. Alternatively, upon accessing system 10 as discussed above, audio project permissions can be presented to the secondary user, including which projects the secondary user can access, edit, or otherwise contribute to. Alternatively, in embodiments, audio project permissions are hidden from the secondary user, but instead presented indirectly by only allowing access to the audio projects to which the secondary user has access. In such embodiments, access would not be granted to those projects which the secondary user does not have access. In embodiments, projects which the secondary does not have access are hidden from the secondary user. At 154, the secondary user can access system 10 and search for a base file belonging to a particular audio project. At 156, optionally, the secondary user can review the base file. In embodiments, reviewing the base file comprises listening to the base file audio component. In embodiments, reviewing the base file comprises reviewing supplemental data coupled or packaged with the base file. The secondary user can therefore determine what kind of stem file is desired for the audio project. At 158, a stem file is provided by the secondary user. In embodiments, as discussed, 158 can comprise the second uploading step 68 of method 50 in which the stem audio file is uploaded to the server 14. Optionally, in embodiments, the audio project can be reviewed by the secondary user. In an embodiment, the audio project can be reviewed after the secondary user has provided a stem file at 158 as a rough draft review of the supplemented base file. In other embodiments, the audio project can be reviewed after the initiating user 12 has approved the stem file; for example, at 108 in method 100 above. In embodiments, the secondary user can optionally review the base file at 156 and provide a second or additional stem file at 158, as illustrated in FIG. 6B. It is readily understood that reference to the secondary user can be applied to tertiary or other of a plurality of users.

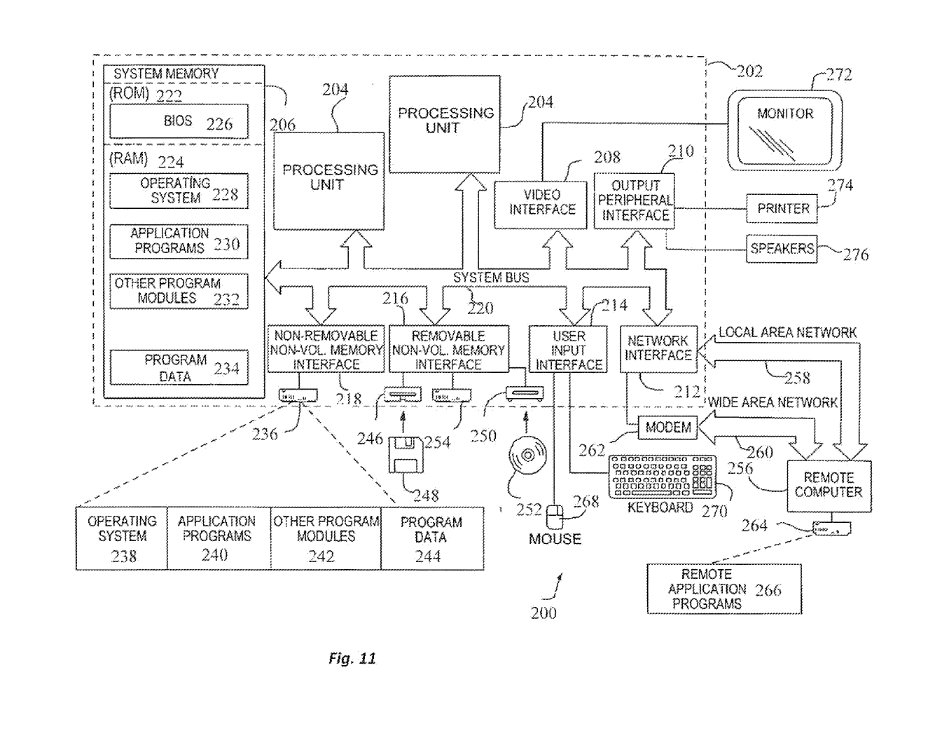

As discussed above, the present invention is generally operated on computer systems such as mobile devices. As depicted in FIG. 11, a computer system 200 on which aspects of the invention as described herein may be implemented according to various embodiments. The computer system 200 may include a computing device such as a personal computer 202. The personal computer 202 includes one or more processing units 204, a system memory 206, a video interface 208, an output peripheral interface 210, a network interface 212, a user input interface 214, removable 216 and non-removable 218 memory interfaces and a system bus or high-speed communications channel 220 coupling the various components. In various embodiments, the processing units 204 may have multiple logical cores that are able to process information stored on computer readable media such as the system memory 206 or memory attached to the removable 216 and non-removable 218 memory interfaces 218. The computer 202 system memory 206 may include non-volatile memory such as Read Only Memory (ROM) 222 or volatile memory such as Random Access Memory (RAM) 224. The ROM 222 may include a basic input/output system (BIOS) 226 to help communicate with the other portion of the computer 202. The RAM 224 may store portions of various software applications such as the operating system 228, application programs 230 and other program modules 232. Further, the RAM 224 may store other information such as program or application data 234. In various embodiments, the RAM 224 stores information that requires low-latencies and efficient access, such as programs and data being manipulated or operated on. In various embodiments RAM 224 comprises Double Data Rate (DDR) memory, Error Correcting memory (ECC) or other memory technologies with varying latencies and configurations such as RAMBUS or DDR2 and DDR3. In this way, in various embodiments, the system memory 206 may store the input data store, access credential data store, operating memory data store, instruction set data store, analysis result data store and the operating memory data store. Further, in various embodiments, the processing units 204 may be configured to execute instructions that limit access to the aforementioned data stores by requiring access credential before access to the information is granted.

The removable 216 and non-removable 218 memory interfaces may couple the computer 202 to disk drives 236 such as SSD or rotational disk drives. These disk drives 236 may provide further storage for various software applications such as the operating system 238, application programs 240 and other program modules 242. Further, the disk drives 236 may store other information such as program or application data 244. In various embodiments, the disk drives 236 store information that doesn't require the same low-latencies as in other storage mediums. Further, the operating system 238, application program 240 data, program modules 242 and program or application data 244 may be the same information as that stored in the RAM 224 in various embodiments mentioned above or it may be different data potentially derivative of the RAM 224 stored data.

Further, the removable non-volatile memory interface 216 may couple the computer 202 to magnetic portable disk drives 246 that utilize magnetic media such as the floppy disk 148, or optical disk drives 250 that utilize optical media 252 for storage of computer readable media such as Blu-Ray®, DVD-R/RW, CD-R/RW and other similar formats. Still other embodiments utilize SSD or rotational disks housed in portable enclosures to increase the capacity of removable memory.

The computer 202 may utilize the network interface 212 to communicate with one or more remote computers 256 over a local area network (LAN) 258 or a wide area network (WAN) 260. The network interface 212 may utilize a Network Interface Card (NIC) or other interface such as a modem 262 to enable communication. The modem 262 may enable communication over telephone lines, coaxial, fiber optic, power line, or wirelessly. The remote computer 256 may contain a similar hardware and software configuration or may have a memory 264 that contains remote application programs 266 that may provide additional computer readable instructions to the computer 202. In various embodiments, the remote computer memory 264 can be utilized to store information such as identified file information that may be later downloaded to local system memory 206. Further, in various embodiments the remote computer 256 may be an application server, an administrative server, client computers, or a network appliance.

A user may enter information to the computer 202 using input devices connected to the user input interface 214 such as a mouse 268 and keyboard 270. Additionally, the input device may be a track pad, fingerprint scanner, joystick, barcode scanner, media scanner or the like. The video interface 208 may provide visual information to a display such as a monitor 272. The video interface 208 may be an embedded interface or it may be a discrete interface. Further, the computer may utilize a plurality of video interfaces 208, network interfaces 212 and removable 216 and non-removable 218 interfaces in order to increase the flexibility in operation of the computer 202. Further, various embodiments utilize several monitors 272 and several video interfaces 208 to vary the performance and capabilities of the computer 202. Other computer interfaces may be included in computer 202 such as the output peripheral interface 210. This interface may be coupled to a printer 274 or speakers 276 or other peripherals to provide additional functionality to the computer 202.

Various alternative configurations and implementations of the computer 202 are within the spirit of the invention. These variations may include, without limitation, additional interfaces coupled to the system bus 220 such as universal serial bus (USB), printer port, game port, PCI bus, PCI Express or integrations of the various components described above into chipset components such as the northbridge or southbridge. For example, in various embodiments, the processing unit 204 may include an embedded memory controller (not shown) to enable more efficient transfer of data from the system memory 206 than the system bus 120 may provide.

The embodiments above are intended to be illustrative and not limiting. Additional embodiments are within the claims. In addition, although aspects of the present invention have been described with reference to particular embodiments, those skilled in the art will recognize that changes can be made in form and detail without departing from the scope of the invention, as defined by the claims.

Persons of ordinary skill in the relevant arts will recognize that the invention may comprise fewer features than illustrated in any individual embodiment described above. The embodiments described herein are not meant to be an exhaustive presentation of the ways in which the various features of the invention may be combined. Accordingly, the embodiments are not mutually exclusive combinations of features; rather, the invention may comprise a combination of different individual features selected from different individual embodiments, as will be understood by persons of ordinary skill in the art.

Any incorporation by reference of documents above is limited such that no subject matter is incorporated that is contrary to the explicit disclosure herein. Any incorporation by reference of documents above is further limited such that no claims that are included in the documents are incorporated by reference into the claims of the present Application. The claims of any of the documents are, however, incorporated as part of the disclosure herein, unless specifically excluded. Any incorporation by reference of documents above is yet further limited such that any definitions provided in the documents are not incorporated by reference herein unless expressly included herein.

For purposes of interpreting the claims for the present invention, it is expressly intended that the provisions of Section 112, sixth paragraph of 35 U.S.C. are not to be invoked unless the specific terms “means for” or “step for” are recited in a claim.

1. A system for aggregating brief audio recordings into a single audio project, the system comprising:
a mobile device comprising a set of instructions executable by mobile device hardware and stored in a mobile device non-transitory storage medium that, when executed, cause the mobile device hardware to implement:
a user interface module adapted to provide a graphical display for a mobile device user;
a recording module accessible through the user interface module and configured to record a base audio file to the mobile device non-transitory storage medium;
an audio file processing module configured to assign an indicator to the base audio file; and
a networking module configured to —
transmit the base audio file and the indicator to a system database,
interface to at least one social network database, the social network database comprising hierarchical relational data for at least the mobile device user, wherein the mobile device user can assign permissions via the user interface for the base audio file to one or more secondary users according to at least the hierarchical relational data.

2. The system of claim 1, wherein the mobile device further comprises a set of instructions executable by the device hardware and stored in the device non-transitory storage medium that, when executed, cause the device hardware to implement:
a timing module configured to limit a length of the base audio file.

3. The system of claim 2, wherein the timing module is accessible through the user interface and further comprises a timer indicator having a changing visual element indicating the difference between a start point and a completion point.

4. The system of claim 1, wherein the mobile device further comprises a set of instructions executable by the device hardware and stored in the device non-transitory storage medium that, when executed, cause the device hardware to implement:
a player module accessible through the user interface and configured to replay the recorded base audio file through the mobile device.

5. The system of claim 1, wherein the networking module is further configured to interface to the system database to allow review of one or more stem audio files by the mobile device user and allow approval of the one or more stem audio files by the mobile device user.

6. The system of claim 1, wherein the networking module is further configured to publish the audio project.

7. The system of claim 1, wherein the user interface module is further configured to display a list of one or more stem audio files related to the base audio file

8. The system of claim 1, wherein the hierarchical relational data comprises a group of first-degree friends of the mobile device user.

9. The system of claim 1, further comprising a second mobile device comprising a set of instructions executable by second device hardware and stored in a second device non-transitory storage medium that, when executed, cause the second device hardware to implement:
a second user interface module adapted to provide a graphical display for a second mobile device user;
a second recording module accessible through the second user interface module and configured to record a stem audio file to the second mobile device non-transitory storage medium;
a second audio file processing module configured to assign a second indicator to the stem audio file, the second indicator indicating at least the relationship of the stem audio file to the base audio file; and
a second networking module configured to transmit the stem audio file and the second indicator to the system database.

10. The system of claim 9, wherein the second mobile device further comprises a set of instructions executable by the second device hardware and stored in the second device non-transitory storage medium that, when executed, cause the second device hardware to implement:
a timing module configured to limit a length of the base audio file, wherein the timing module is accessible through the second user interface and further comprises a timer indicator having a changing visual element indicating the difference between a start point and a completion point, at least one of the start point or completion point defined by the second indicator.

11. The system of claim 9, wherein the networking module is further configured to interface to the system database to allow a search of base audio files by the second mobile device user.

12. The system of claim 11, wherein the search of base audio files is limited by the system database according to relational contact data assigned by the mobile device user.

13. A method for aggregating brief audio recordings into a single audio project, the method being executable by a computer system that includes computer hardware, the method comprising:
providing an initiating client to a first mobile device;
receiving, from the initiating client, a base audio file and a primary indicator associated with the base audio file;
receiving, from the initiating client, a permission assignment for the base audio file for one or more secondary clients according to at least hierarchical relational data;
storing the base audio file and the primary indicator in a storage module;
providing a secondary client to a second mobile device;
receiving, from the secondary client, a search query related to the base audio file;
searching the storage module according to the search query related to the base audio file;
providing, to the secondary client, the base audio file;
receiving, from the secondary client, a stem audio file and a secondary indicator, wherein the secondary indicator indicates at least the relationship of the stem audio file to the base audio file; and
aggregating the stem audio file with the base audio file according to the primary indicator and the secondary indicator.

14. The method of claim 13, wherein providing the initiating client to the first mobile device comprises installing, on the first mobile device, a set of instructions executable by mobile device hardware and stored in a mobile device non-transitory storage medium that, when executed, cause the mobile device hardware to implement:
a user interface module adapted to provide a graphical display for a mobile device user;
a recording module accessible through the user interface module and configured to record the base audio file to the mobile device non-transitory storage medium;
an audio file processing module configured to assign the primary indicator to the base audio file; and
a networking module configured to transmit the base audio file and the primary indicator to the computer system.

15. The method of claim 13, wherein providing the secondary client to the second mobile device comprises installing, on the second mobile device, a set of instructions executable by second mobile device hardware and stored in a second mobile device non-transitory storage medium that, when executed, cause the second mobile device hardware to implement:
a second user interface module adapted to provide a graphical display for a second mobile device user;
a second recording module accessible through the second user interface module and configured to record the stem audio file to the second mobile device non-transitory storage medium;
a second audio file processing module configured to assign the secondary indicator to the stem audio file; and
a second networking module configured to transmit the stem audio file and the secondary indicator to the computer system.

16. The method of claim 13, further comprising:
providing a tertiary client to a tertiary mobile device;
receiving, from the tertiary client, a search query related to the base audio file;
searching the storage module according to the search query related to the base audio file;
providing, to the tertiary client, the base audio file;
receiving, from the tertiary client, a second stem audio file and a tertiary indicator, wherein the tertiary indicator indicates at least the relationship of the second stem audio file to the base audio file; and
aggregating the second stem audio file with the base audio file according to the primary indicator and the tertiary indicator.

17. A method for aggregating brief audio recordings into a single audio project, the audio project comprising a base audio file and at least one stem audio file, the method being executable by a computer system that includes computer hardware, the method comprising:
accessing a contact database, the contact database comprising hierarchical relational data for a computer system user;
assigning contact permissions for the audio project according to the hierarchical relational data;
recording a base audio file;
reviewing at least one stem audio file;
approving the at least one reviewed stem audio file; and
publishing the audio project.

18. The method of claim 17, wherein assigning contact permissions comprises assigning at least one permission based on a friendship hierarchy derived from the contact database.

19. The method of claim 17, further comprising delegating contact permission assignment control to a secondary user.

20. The method of claim 19, further comprising reclaiming contact permission assignment control from the secondary user.
